(19) United States
(12) Patent Application Publication
(10) Pub. No.: US 2013/0058092 A1
(43) Pub. Date: Mar. 7, 2013

(54) Dynamic Laser Pointer

(71) Applicant: Igor Anisimov, Dayton, OH (US)

(72) Inventor: Igor Anisimov, Dayton, OH (US)

(73) Assignee: Government of the United States, as represented by the Secretary of the Air Force, Wright-Patterson AFB, OH (US)

(21) Appl. No.: 13/225,714

(22) Filed: Sep. 6, 2011

(51) Int. Cl. G02B 27/20

(52) U.S. Cl. 362/259

(57) ABSTRACT

A dynamic laser pointer is provided having a laser configured to emit visible light. A lens is configured to collimate the visible light emitted from the laser. A reflector includes a plurality of independent, controllable reflective surfaces. Each surface is configured to independently steer a portion of the collimated visible light dynamically in time.

### RIGHTS OF THE GOVERNMENT

The invention described herein may be manufactured and used by or for the Government of the United States for all governmental purposes without the payment of any royalty.

### FIELD OF THE INVENTION

The present invention relates to a laser pointer, and more particularly to a laser pointer which can dynamically project a laser beam or beams onto remote objects.

### BACKGROUND OF THE INVENTION

Since the manufacturing of affordable semiconductor laser sources, lasers are widely used as reliable, small size and weight sources of illumination. Contemporary laser pointers project laser beams onto remote objects such as presentations, remote targets, mechanical parts for aiding in identifying the objects or parts of the objects. However, contemporary laser pointers project a single spot, and the single spot is generally unable to cover a certain range of information so that the users need to wave or shake the laser point when attempting to indicate or emphasize certain areas of the image or part of the object.

In order to overcome the above disadvantages of the conventional laser pointer with single spot, some non-spot laser pointers are also available. For example, some lasers pointers may be configured to project a linear image instead of a single spot, but the length of the linear image is generally unable to be adjusted. Other laser pointers may be disposed with a holographic element or a diffractive optical element so as to project non-spot laser images. By changing the holographic element, a different laser image is projected. But, even with the diffractive optical element, the size and location of the laser image is unable to be changed according to a user's needs. Thus, when the laser image is unable to label or cover a certain area, the user still needs to wave the laser pointer for emphasis. And, both the spot and non-spot lasers also only indicate one location at a time, again forcing the user to move the output of the laser pointer between multiple points on the object to emphasize those areas.

What is needed, therefore, is a laser pointer that is able to more accurately project laser output on an object, presentation, etc. and enable a user to emphasize multiple locations simultaneously.

### SUMMARY OF THE INVENTION

Embodiments of the invention address the need in the art by providing a dynamic laser pointer configured to project multiple laser images and the locations of these images may be controlled over time. The dynamic laser pointer has a laser configured to emit visible light. A lens is configured to collimate the visible light emitted from the laser. A reflector is utilized which contains a plurality of independent, controllable reflective surfaces. Each surface is configured to independently steer a portion of the collimated visible light. In some embodiments, the reflector may be a MEMS micro mirror array, a liquid crystal optical phased array, or a piezo controlled mirror.

In some embodiments, the dynamic laser pointer includes a second lens configured to focus the independently steered portions of the collimated visible light as a spot. Additionally, embodiments may include electronic controls configured to control the plurality of reflective surfaces. In these embodiments, the electronic controls may include a microprocessor, an ASIC, a FPGA, etc. Alternatively, the electronic controls may include a port configured to control the plurality of reflective surfaces via an external device. Some embodiments may also use multiple lasers with different output wavelengths in order to project multiple independent beams with various colors.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a schematic diagram of an embodiment employing a single laser.

FIG. 2 is a schematic diagram of an embodiment employing multiple lasers.

FIG. 3 is an assembly diagram of the embodiment in FIG. 1.

FIG. 4 is an isometric, cut-away view of the assembly diagram in FIG. 3.

FIG. 5 illustrates an instructional musical application of embodiments of the invention.

FIGS. 6A and 6B illustrate an instructional typing application of embodiments of the invention.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

Contemporary laser pointer devices project a laser beam onto remote objects producing a laser image spot, which may be shaped as a dot or a line, or any other shape by projecting the laser beam through diffractive optical elements. The remote object may be a presentation, a poster, a distant target, a mechanical part, etc. The laser pointer device may be handheld or attached to a handgun, power tool or any other type of equipment. There are many new small sized laser beam control devices such as micro-mirror arrays (MMA) controlled by micro-electro-mechanical systems (MEMS). In these devices, micro-mirrors can change the direction of the laser beams up to approximately 30 degrees in two dimensions by applying small electrical signals to the electrodes of the device. Multiple laser beams may be controlled independently. Other types of laser beam steering devices may include liquid crystal optical phased arrays, piezo controlled mirrors and others. By coupling a laser beam steering device to a laser pointer, a new dynamic laser pointing apparatus may be constructed. The dynamic laser pointer may project multiple laser images (dots or lines) on to remote objects, and the location of the images may be controlled as a function of time by a microprocessor or other external electrical signals.

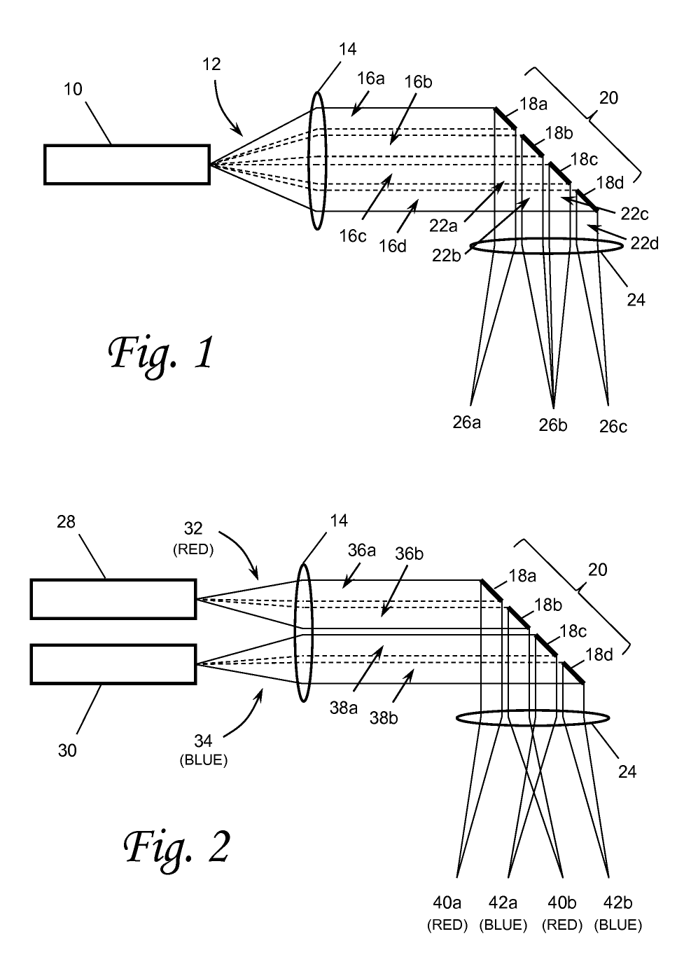

Turning to the drawings, where like numbers denote like parts throughout the several views, FIG. 1 illustrates the basic components of some embodiments of the invention. A laser 10 projects visible light 12 to a first lens 14. Portions of the visible light 16a-16d are reflected by one or more individual mirrors 18a-18d making up a MEMS MMA 20. The reflected portions 22a-22d are focused using a second lens 24 into one or more spots 26a-26c. Locations of these spots may be controlled electronically using a USB connected personal computer or Smart Phone. Alternatively, a self-contained microprocessor, ASIC, or FPGA may also be used. Utilizing a MEMS MMA 20 enables embodiments of the invention to direct the portions of the visible light 16a-16d independently of the other portions of the visible light 16a-16d. While a MEMS MMA 20 is well suited to direct the potions of the visible light 16a-16d, other mirror or reflective devices that are capable of independent movement within the mirror or reflective device may also be utilized, such as liquid crystal optical phased arrays, piezo controlled mirrors, etc.

Other embodiments of the invention may employ multiple lasers. For example, and as seen in FIG. 2, two lasers 28, 30 may be used. In some embodiments, each of these lasers may emit light at different wavelengths, producing a different color of visible light 32, 34, such as red and blue respectively, for example. The visible light 32, 34 is projected toward the first lens 14 as above and portions of that light 36a, 36b, 38a, 38b are reflected by one or more individual mirrors 18a-18d making up the MEMS MMA 20. Similarly, the second lens 24 focuses the reflected portions of light 36a, 36b, 38a, 38b into spots 40a, 40b, 42a, and 42b. As above these spots may be directed to specific locations electronically using a USB connected personal computer or Smart Phone, or a self-contained microprocessor, ASIC, or FPGA. Spots 40a, 40b, 42a, 42b may also be combined as a single spot, creating additional colors based on the mixing of the reflected laser light colors. With any of the embodiments above, the number of controllable spots produced by the embodiments is only limited by the reflective surface independently directing the portions of the visible light.

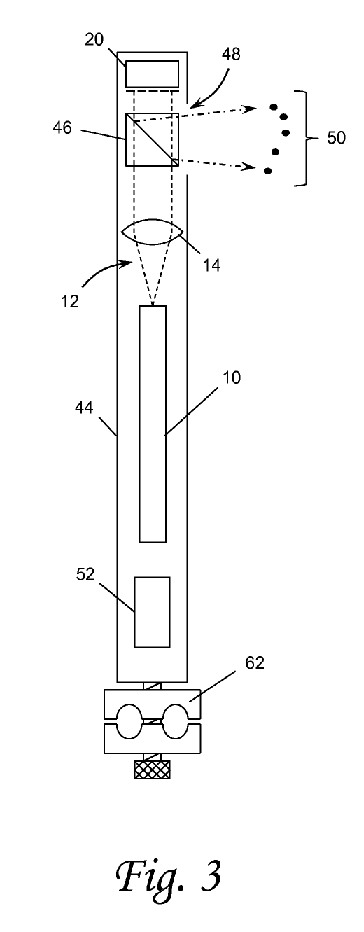

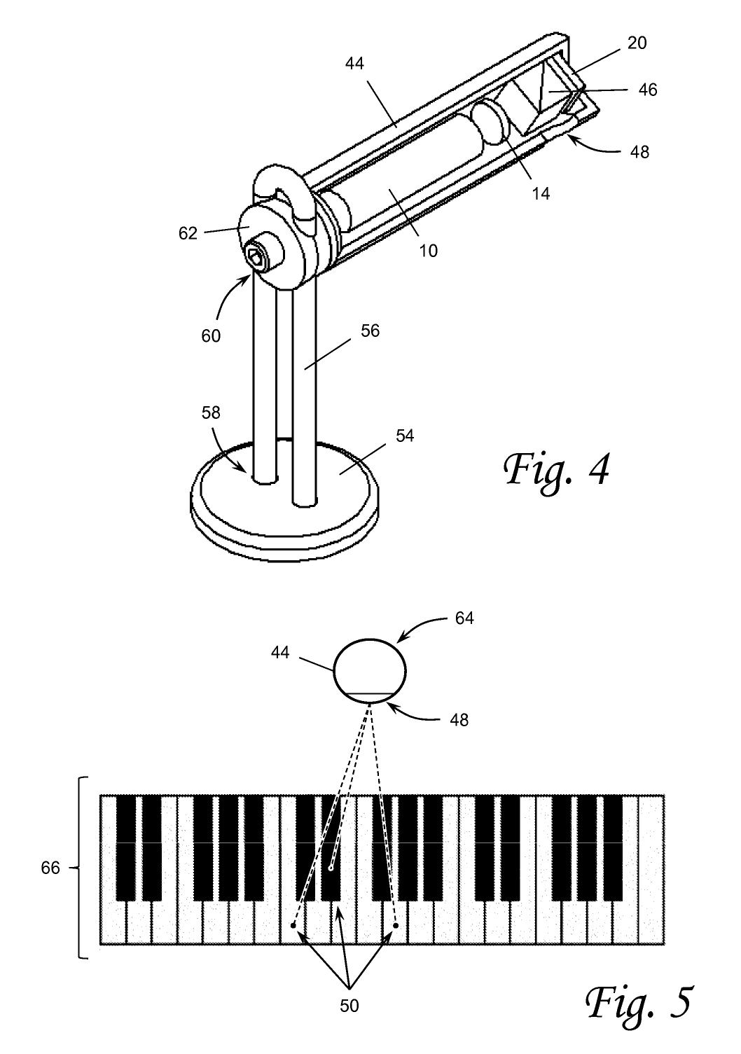

Embodiments of the invention may be packaged in a number of ways. The embodiments may be configured as a hand held device or as a free standing device. FIGS. 3 and 4 illustrate an embodiment of the invention in a free standing configuration. In this configuration, the laser 10 and the first lens 12 may be located in a housing 44. Visible light 12 from the laser 10 is directed toward the first lens 12. This light, is then directed toward a beam splitter 46 where a portion of the visible light 12 is directed toward the MEMS MMA 20. The reflected portions of the visible light 12 are then directed by the beam splitter 46 to an aperture 48 producing one or more visible spots 50. Electronic controls 52 may also be included in the housing 44, such as a processor or other integrated circuit as set forth above. Alternatively, a port, such as a USB port, may be configured in the housing 44 and may be used to control the laser 10 output as well as control the MEMS MMA 20.

The housing 44 may be mounted on a free standing mounting configuration such as a base 54 and support member 56. Support member 56 may have a first end 58 coupled with the base 54 and a second end 60 detachably coupled to the housing 44, via a clamping 62 or other type mechanism. Such a mechanism may also allow the housing 44 to be positioned at different locations along a length of the support member 56. Other embodiments, may attach the housing 44 to other rigid structures, or in some embodiments, housing 44 may be adapted to be hand held.

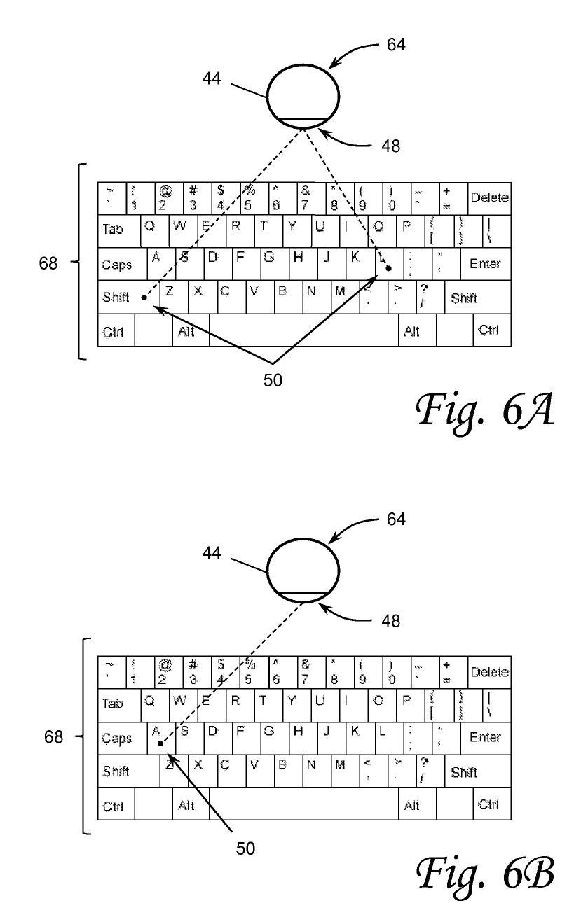

Applications of the embodiments of the invention may include presentations, demonstrations, classroom training, entertainment, manufacturing, or any other application where it may be necessary to simultaneously point to or indicate more than one object and change the location of the pointing beams dynamically in time. For example, an embodiment of then invention may be used as a teaching tool for playing musical instruments. The laser spots may be projected onto various parts of the musical instrument and will change locations in accordance with the musical composition. As seen in FIG. 5, the dynamic laser pointer 64 may be programmed to display spots 50 on a plano keyboard 66. These spots would dynamically change between keys on the keyboard 66 as an individual learns to play a new song. Multiple spots 50 may be displayed when multiple notes are to be played. Similarly the spots may be directed to the fret of a string instrument or keys on a woodwind instrument. Alternatively, the dynamic laser pointer 64 may be used as a typing aid, as seen in FIGS. 6A and 6B, displaying spots on particular keys on a computer or other keyboard 68 while learning to type. Additionally, in other embodiments, the dynamic laser pointer 64 may be used as a warning indicator, which may point bright beam spots on parts of a control panel of an aircraft, boat, or other vehicle, during training or as a safety device.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. An apparatus comprising:
a laser configured to emit visible light;
a lens configured to collimate the visible light emitted from the laser; and
a reflector having a plurality of independent, controllable reflective surfaces, each surface configured to independently steer a portion of the collimated visible light dynamically in time.

2. The apparatus of claim 1, wherein the lens is a first lens, the apparatus further comprising:
a second lens configured to focus the independently steered portions of the collimated visible light as a spot.

3. The apparatus of claim 1, further comprising:
electronic controls configured to control the plurality of reflective surfaces.

4. The apparatus of claim 3, wherein the electronic controls include a microprocessor.

5. The apparatus of claim 3, wherein the electronic controls include an ASIC.

6. The apparatus of claim 3, wherein the electronic controls include a FPGA.

7. The apparatus of claim 3, wherein the electronic controls include a port configured to control the plurality of reflective surfaces via an external device.

8. The apparatus of claim 7, wherein the port is a USB port.

9. The apparatus of claim 7, wherein the external device is a computer.

10. The apparatus of claim 7, wherein the external device is a Smart Phone.

11. The apparatus of claim 1, wherein the reflector is a MEMS micro mirror array.

12. The apparatus of claim 1, wherein the reflector is a liquid crystal optical phased array.

13. The apparatus of claim 1, wherein the reflector is a piezo controlled mirror.

14. The apparatus of claim 1, wherein the laser is a first laser configured to emit visible light at a first wavelength, the apparatus further comprising:
a second laser configured to emit visible light at a second wavelength;
the lens configured to collimate the visible light at the second wavelength emitted from the second laser; and
each surface of the plurality of independent, controllable reflective surfaces of the reflector further configured to independently steer a portion of the collimated visible light from the second laser dynamically in time.
